(19) United States
(12) Patent Application Publication
(10) Pub. No.: US 2025/0025992 A1
(43) Pub. Date: Jan. 23, 2025

(54) CV AXLE PULLER

(71) Applicant: Jordan Wilking, Boerne, TX (US)

(72) Inventor: Jordan Wilking, Boerne, TX (US)

(21) Appl. No.: 18/353,174

(22) Filed: Jul. 17, 2023

(51) Int. Cl. B25B 27/02

(52) U.S. Cl. CPC B25B 27/02

(57) ABSTRACT

A CV axle puller is provided. The CV axle puller includes a first clamp member having a first curved surface and a first pulling member; and a second clamp member having a second curved surface and a second pulling member. The first clamp member and the second clamped member are coupled together with the first curved surface facing the second curved surface to form a clamp axis. The first and second pulling members are parallel to the clamp axis. The first clamp member and the second clamp member clamp around a housing of a CV axle with the first curved surface and the second curved surface engaging an outer curved surface of the housing of the CV axle. A flexible force applying member may be coupled between the first and second pulling members and used to apply a force to dislodge the CV axle from a differential.

### BACKGROUND OF THE INVENTION

### Technical Field

This invention relates generally to a CV axle tool and more particularly to a CV axle puller for removing a CV axle from a differential.

### State of the Art

A CV axle, or Constant Velocity axle, is a shaft or axle that transmits power from a vehicle's differential to the wheels of the vehicle without velocity fluctuations even when the wheels are turned. The CV axle also can account for any changes in wheel geometry from tie rods, as well as changes to operational angle from turning, suspension modulations, and the like and maintain the input and output speed at the same constant velocity. This functionality renders the CV axle and essential component of any vehicle. When a CV axle is bad or failing, it needs to be replaced. The removal of the CV axle from its connection with the vehicle differential can be exceedingly difficult due to wear and tear on the vehicle's CV axle. Conventionally, removal of the CV axle is performed by removing the end of the CV axle from the wheel hub and then grabbing the CV axle and applying force by pulling on the CV axle to dislodge it from the differential. This conventional way of removing the CV axle in instances where the CV axle is bound or difficult to remove, and thereby requires additional time and effort for removal.

Accordingly, there is a need for a unique CV axle puller that can assist in the removal of the CV axle from the differential of the vehicle.

### SUMMARY OF THE INVENTION

An embodiment of the present invention includes a CV axle puller comprising: a first clamp member having a first curved surface and a first pulling member; and a second clamp member having a second curved surface and a second pulling member, wherein the first clamp member and the second clamped member are releasably coupled together with the first curved surface facing the second curved surface to form a clamp axis, wherein: the first pulling member and the second pulling member are parallel to the clamp axis and extend in a same direction from the first clamp member and the second clamp member; and the first clamp member and the second clamp member are configured to clamp around a housing of a CV axle with the first curved surface and the second curved surface engaging an outer curved surface of the housing of the CV axle.

Another embodiment of the present invention includes a method of using a CV axle puller, the method comprising: coupling the CV axle puller to a housing of the CV axle, the CV axle puller having a clamp axis; coupling a flexible force applying member to the CV axle puller; and applying an abrupt force pulled in a direction substantially coaxially with the clamp axis and away from a differential the CV axle is coupled to and thereby applying an abrupt force to the housing of the CV axle through the CV axle puller for dislodging the CV axle from the differential.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a perspective view of a CV axle puller according to an embodiment;

FIG. 2 is another perspective view of a CV axle puller according to an embodiment;

FIG. 3 is an end view of a CV axle puller according to an embodiment;

FIG. 4 is an exploded perspective view of a CV axle puller according to an embodiment;

FIG. 5 is a perspective view of a CV axle puller with a flexible force applying member and a handle coupled thereto according to an embodiment;

FIG. 6 is a perspective view of a CV axle puller coupled to a housing of a CV axle according to an embodiment; and

FIG. 7 depicts a clow chart of a method of using a CV axle puller according to an embodiment.

### DETAILED DESCRIPTION OF EMBODIMENTS OF THE INVENTION

As discussed above, embodiments of the present invention relate to a CV axle puller for removing a CV axle from a differential.

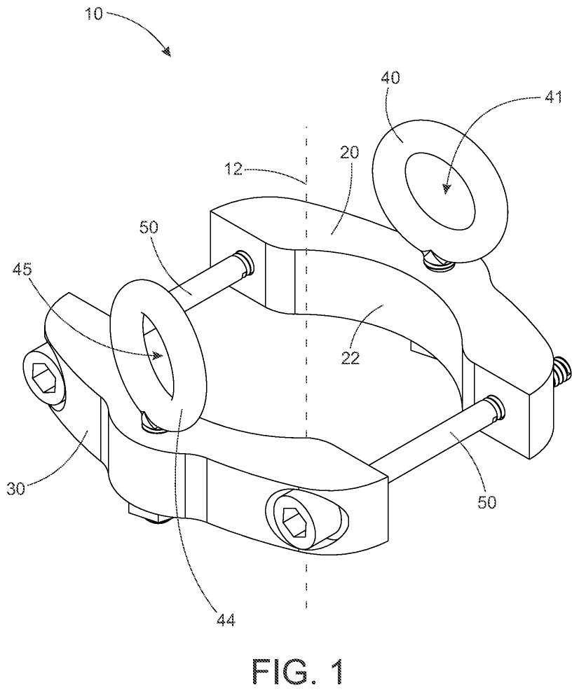

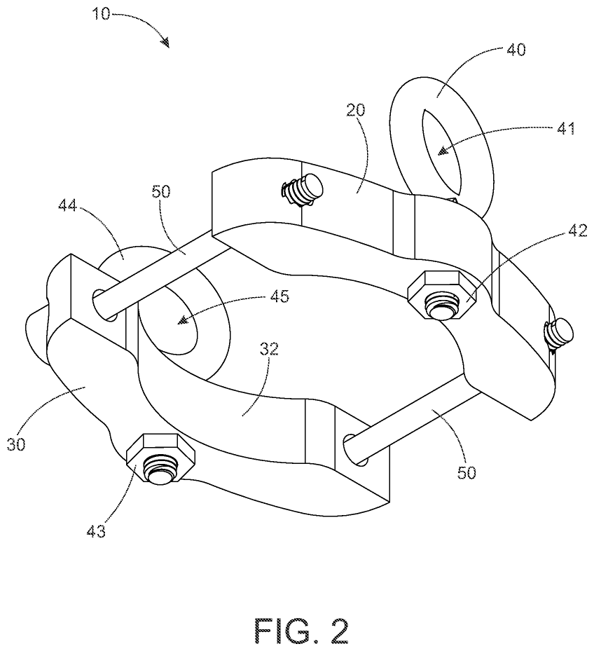

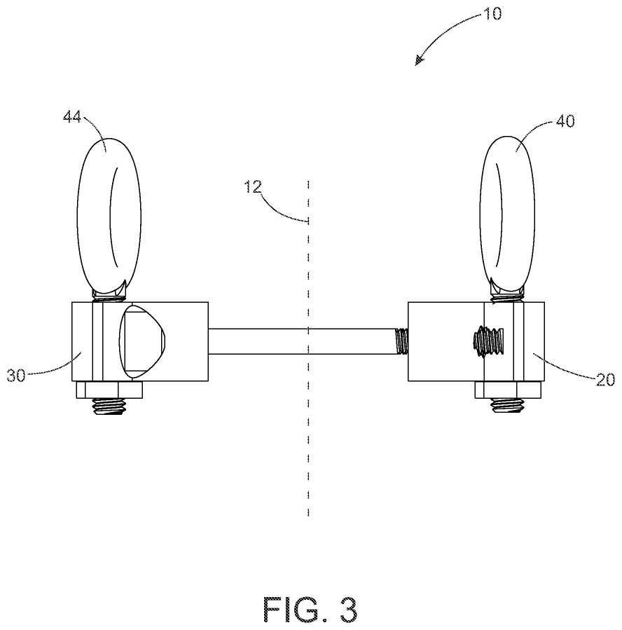

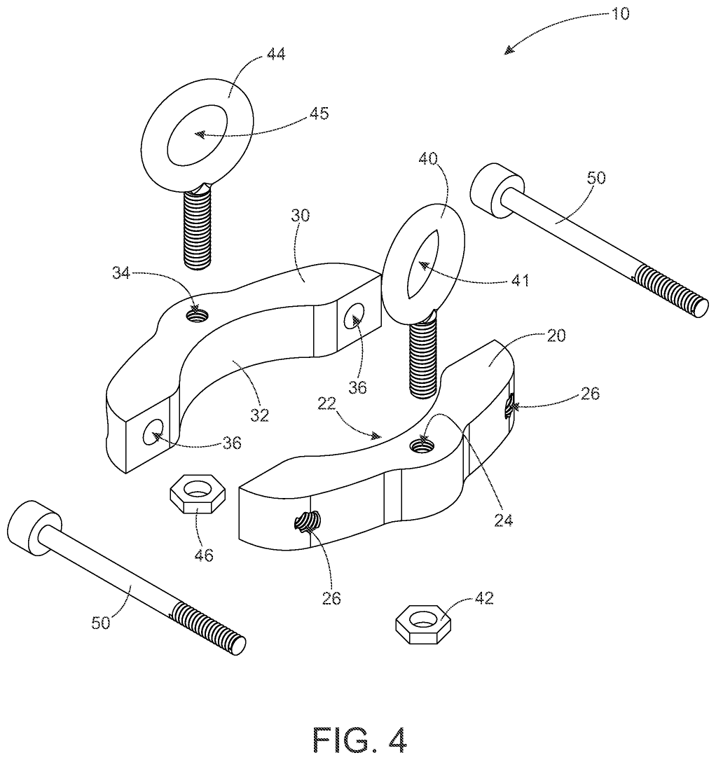

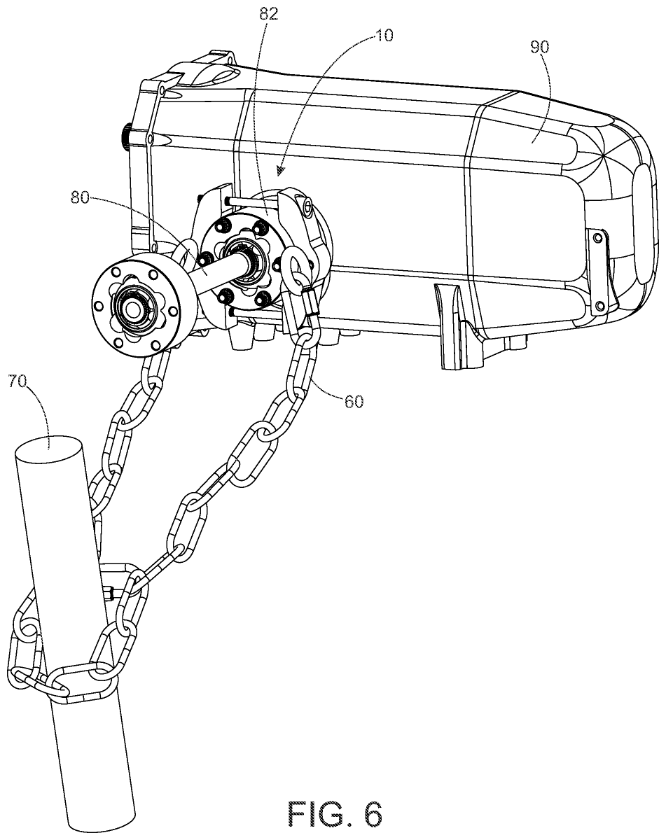

Referring to FIGS. 1-4, an embodiment of a CV axle puller 10 is depicted. The CV axle puller 10 may comprise a first clamp member 20 having a first curved surface 22 and a first pulling member 40; and a second clamp member 30 having a second curved surface 32 and a second pulling member 44. The first clamp member 20 and the second clamped member 30 may be releasably coupled together with the first curved surface 22 facing the second curved surface 32 to form a clamp axis 12. The first pulling member 40 and the second pulling member 44 may be parallel to the clamp axis 12 and extend in a same direction from the first clamp member 20 and the second clamp member 30. The first clamp member 20 and the second clamp member 30 are configured to clamp around a housing 82 of a CV axle 80 with the first curved surface 22 and the second curved surface 32 engaging an outer curved surface of the housing 82 of the CV axle 80 as shown in FIG. 6.

The first clamp member 20 may include a first puller aperture 24 extending through the first clamp member 20 from a front surface to a rear surface of the first clamp member 20. The first puller aperture 24 may be coupled to the first pulling member 40, such as, but not limited to, a threaded engagement between the first pulling member 40 and the first puller aperture 24. In embodiments, the first pulling member 40 may comprise a first aperture 41 located at an end. In embodiments, the first pulling member 40 may be an eye bolt with the first aperture 41 as depicted in the drawing figures. In these embodiments where the first pulling member 40 is an eye bolt, a first nut 42 may be utilized to further secure the first pulling member 40 to the first clamp member 20.

The second clamp member 30 may include a second puller aperture 34 extending through the second clamp member 30 from a front surface to a rear surface of the second clamp member 30. The second puller aperture 34 may be coupled to the second pulling member 44, such as, but not limited to, a threaded engagement between the second pulling member 44 and the second puller aperture 34. In embodiments, the second pulling member 44 may comprise a second aperture 45 located at an end. In embodiments, the second pulling member 44 may be an eye bolt with the second aperture 45 as depicted in the drawing figures. In these embodiments where the second pulling member 44 is an eye bolt, a second nut 44 may be utilized to further secure the second pulling member 44 to the second clamp member 30.

The first clamp member 20 may include two coupler apertures 26 on opposing ends of the first clamp member 20, wherein the coupler apertures 26 are transverse to the first puller aperture 24. The second clamp member 30 may include two coupler apertures 36 on opposing ends of the second clamp member 30, wherein the coupler apertures 36 are transverse to the second puller aperture 34. The coupler apertures 26 of the first clamp member 20 correspond with the coupler apertures 36 of the second clamp member 30. Couplers 50 may operate to couple the first clamp member 20 with the second clamp member 30 through the coupler apertures 26 and 36, respectively. The coupler apertures 26 and 36 are oriented such that when the first clamp member 20 is coupled to the second clamp member 30, the first curved surface 22 of the first clamp member 20 faces the second curved surface 32 of the second clamp member 30 to form a clamp axis 12. The couplers 50 may be adjustable, such as an Allen bolt wherein one of the coupler apertures 26 or 36 are threaded and the Allen bolt engages the threads and may adjust the space between the first curved surface 22 and the second curved surface 32. In this way the CV axle puller may be coupled to housings 82 that vary in size.

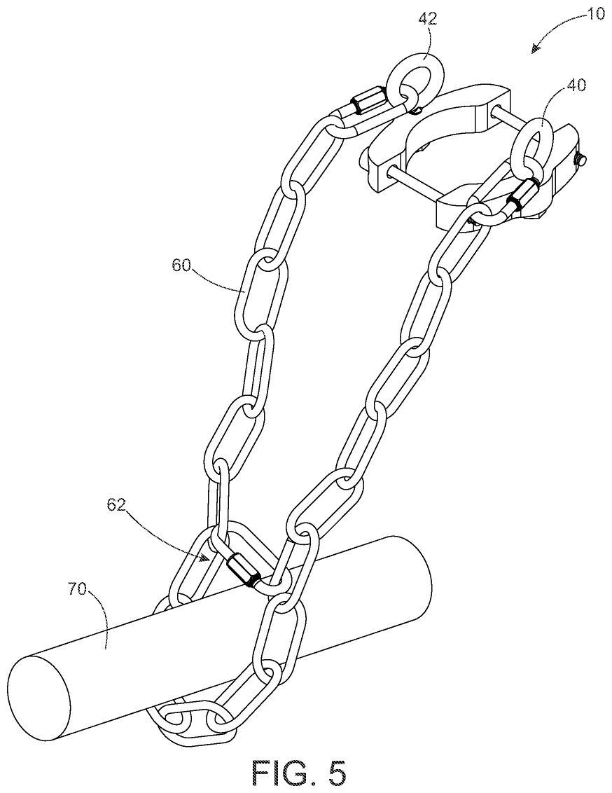

Referring further to FIGS. 5-6, the CV axle puller 10 may further comprise a flexible force applying member 60 coupled between the first aperture 41 of the first pulling member 40 and the second aperture 45 of the second pulling member 44. The CV axle puller 10 may further comprise a handle 70 coupled to a mid-point 62 of the flexible force applying member 60, wherein the handle 70 is configured to be abruptly pulled in a direction substantially coaxially with the clamp axis 12 and away from a differential 90 the CV axle 80 is coupled to. This then applies an abrupt force to the housing 82 of the CV axle 80 through the CV axle puller 10 for dislodging the CV axle 80 from the differential 90. In embodiments, the flexible force applying member 60 may be a chain and the midpoint 62 may form a loop formed in the chain to slide the handle 70 into. The handle may be any type of handle from a hammer to a rod and other forms of a handle.

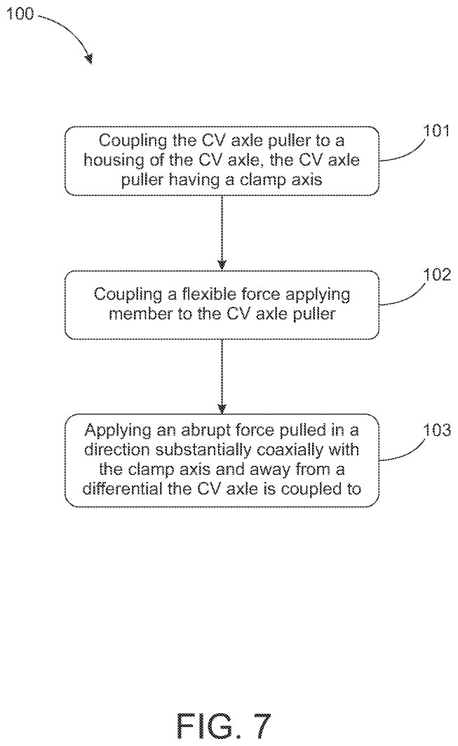

Referring further to FIG. 7, another embodiment may include a method 100 of using a CV axle puller 10. The method 100 may include coupling the CV axle puller to a housing of the CV axle, the CV axle puller having a clamp axis (Step 101); coupling a flexible force applying member to the CV axle puller (Step 102); and applying an abrupt force pulled in a direction substantially coaxially with the clamp axis and away from a differential the CV axle is coupled to (Step 103) and thereby applying an abrupt force to the housing of the CV axle through the CV axle puller for dislodging the CV axle from the differential.

Step 101 of coupling the CV axle puller to the housing of the CV axle may comprise clamping the first clamp member and the second clamp member around the housing of a CV axle with the first curved surface and the second curved surface engaging an outer curved surface of the housing of the CV axle. It will be understood that clamping the first clamp member and the second clamp member around the housing of the CV axle may comprise adjustably coupling the first clamp member to the second clamp member to adjust the distance between the first curved surface and the second curved surface to account for different sized housings.

In method 100, prior to Step 103 of applying the abrupt force, the method 100 may comprise releasably coupling a handle to a midpoint of the flexible force applying member. Then, Step 103 of applying the abrupt force pulled in a direction substantially coaxially with the clamp axis may be accomplished in response to applying an abrupt force to the handle in a direction substantially coaxially with the clamp axis.

Step 102 of coupling the flexible force applying member to the CV axle puller may further comprise coupling the flexible force applying member between a first aperture of a first pulling member and the second aperture of the second pulling member.

It will be understood that in embodiments, Step 103 of applying an abrupt force pulled in a direction substantially coaxially with the clamp axis and away from a differential the CV axle is coupled to may refer to applying a force that does not need to be exactly aligned with the clamp axis but in the general direction along the clamp axis and away from the differential.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A CV axle puller comprising:
a first clamp member having a first curved surface and a first pulling member; and
a second clamp member having a second curved surface and a second pulling member, wherein the first clamp member and the second clamped member are releasably coupled together with the first curved surface facing the second curved surface to form a clamp axis, wherein:
the first pulling member and the second pulling member are parallel to the clamp axis and extend in a same direction from the first clamp member and the second clamp member; and
the first clamp member and the second clamp member are configured to clamp around a housing of a CV axle with the first curved surface and the second curved surface engaging an outer curved surface of the housing of the CV axle.

2. The CV axle puller of claim 1, wherein the first pulling member comprises a first aperture and the second pulling member comprises a second aperture.

3. The CV axle puller of claim 2, further comprising a flexible force applying member coupled between the first aperture of the first pulling member and the second aperture of the second pulling member.

4. The CV axle puller of claim 3, further comprising a handle coupled to a mid-point of the flexible force applying member, wherein the handle is configured to be abruptly pulled in a direction substantially coaxially with the clamp axis and away from a differential the CV axle is coupled to and applies an abrupt force to the housing of the CV axle for dislodging the CV axle from the differential.

5. The CV axle puller of claim 2, wherein the first pulling member and the second pulling member are each an eye bolt.

6. The CV axle puller of claim 3, wherein the flexible force applying member is a chain.

7. The CV axle puller of claim 1, wherein the first clamp member and the second clamp member are adjustably coupled together, wherein the distance between the first curved surface and the second curved surface is adjustable to account for different sized housings of the CV axle.

8. A method of using a CV axle puller, the method comprising:
coupling the CV axle puller to a housing of the CV axle, the CV axle puller having a clamp axis;
coupling a flexible force applying member to the CV axle puller; and
applying an abrupt force pulled in a direction substantially coaxially with the clamp axis and away from a differential the CV axle is coupled to and thereby applying an abrupt force to the housing of the CV axle through the CV axle puller for dislodging the CV axle from the differential.

9. The method of claim 8, wherein the CV axle puller comprises:
a first clamp member having a first curved surface and a first pulling member; and
a second clamp member having a second curved surface and a second pulling member, wherein the first clamp member and the second clamped member are releasably coupled together with the first curved surface facing the second curved surface to form the clamp axis, and wherein the first pulling member and the second pulling member are parallel to the clamp axis and extend in a same direction from the first clamp member and the second clamp member.

10. The method of claim 9, wherein coupling the CV axle puller to the housing of the CV axle comprises clamping the first clamp member and the second clamp member around the housing of a CV axle with the first curved surface and the second curved surface engaging an outer curved surface of the housing of the CV axle.

11. The method of claim 10, wherein clamping the first clamp member and the second clamp member around the housing of the CV axle comprises adjustably coupling the first clamp member to the second clamp member to adjust the distance between the first curved surface and the second curved surface to account for different sized housings.

12. The method of claim 8, wherein prior to applying the abrupt force, the method comprises releasably coupling a handle to a midpoint of the flexible force applying member.

13. The method of claim 12, wherein applying the abrupt force pulled in a direction substantially coaxially with the clamp axis is accomplished in response to applying an abrupt force to the handle in a direction substantially coaxially with the clamp axis.

14. The method of claim 9, wherein the first pulling member comprises a first aperture and the second pulling member comprises a second aperture.

15. The method of claim 14, wherein coupling the flexible force applying member to the CV axle puller further comprising coupling the flexible force applying member between the first aperture of the first pulling member and the second aperture of the second pulling member.

16. The method of claim 14, wherein the first pulling member and the second pulling member are each an eye bolt.

17. The method of claim 14, wherein the flexible force applying member is a chain.
